(19) United States
(12) Patent Application Publication
(10) Pub. No.: US 2021/0086218 A1
(43) Pub. Date: Mar. 25, 2021

(54) Dispensing System and Method for Dispensing a Slurry or Glaze to Build or Print Products of the Ceramics Industry, in Particular Ceramic Tiles

(71) Applicants: SCG BUILDING MATERIALS CO., LTD., BANGKOK (TH); SCG CERAMICS PUBLIC CO., LTD., BANGKOK (TH)

(72) Inventors: Sutee NOGTIEN, BANGKOK (TH); Terdwong JAMRUSSAMEE, BANGKOK (TH); Anupol PONGKASUD, BANGKOK (TH); Chalermpol MOLTATHONG, BANGKOK (TH)

(21) Appl. No.: 16/499,147

(22) PCT Filed: Mar. 21, 2018
(86) PCT No.: PCT/IB2018/051892

§ 371 Date: Sep. 27, 2019

(30) Foreign Application Priority Data
Mar. 27, 2017 (IT) 102017000033389

(51) Int. Cl. B05B 15/58; B05B 7/32; B05C 11/10; B41J 3/407; B28B 11/04; B28B 1/00; B28B 11/00; B28B 17/00; B44F 9/04

(52) U.S. Cl. CPC B05B 15/58; B05B 7/32; B05C 11/101; B05C 11/1013; B05C 11/1036; B44F 9/04; B28B 11/044; B28B 1/005; B28B 11/001; B28B 17/0081; B41J 3/407

(57) ABSTRACT

A dispensing system for dispensing a slurry or glaze for making or printing products of the ceramic industry comprises a plurality of reservoirs suitable for containing a respective fluid mixture or glaze and at least one dispenser associated with the reservoirs and equipped with at least one outlet for dispensing the fluid mixture. The system further comprises at least one mixer operatively interposed between the reservoirs and the dispenser, and configured to receive the fluid mixture from each reservoir and to send a mixed fluid to the dispenser, adjusting means operatively interposed between each reservoir and the mixer, and a control unit associated with the adjusting means and configured to drive them so as to adjust the mixing ratio between the flow rates of fluid mixtures into the mixer depending on a reference signal related to a predetermined hue of the mixed fluid.

### CROSS-REFERENCE TO RELATED APPLICATIONS

This application is a US 371 Application from PCT/IB/2018/051892 filed Mar. 21, 2018, which claims priority to Italian Application 102017000033389 filed Mar. 27, 2017, the technical disclosures of which are hereby incorporated herein by reference.

The present invention relates to a dispensing system and method for dispensing a slurry or glaze for making or printing ceramic industry products, in particular ceramic tiles.

As a result, the present invention finds its particular and preferred application in the manufacturing industry, in particular in the printing, glazing and colouring (for example, screen-printing) of ceramic slabs, concrete products etc.

More specifically, the present invention finds its application in the realization of tiles and products which aim to reproduce the patterns and shades of natural stones by means of the uneven juxtaposition of glazes of different colours or hues.

To date, the only method known of the prior art for making products of this type lies in the arrangement in series of a plurality of bars or dispensers, each associated with a glaze reservoir and suitably controlled in synergy with the motion means of the product and/or dispenser.

As a result, in order to achieve the desired pattern, the reservoirs for each individual outlet are filled with specially made glazes, sometimes previously mixed, and subsequently the production system is started checking only the “mechanical” parameters relative to the dispensing rates of the heads and the relative speed of motion between the outlet and the product.

Unfortunately, this procedure is extremely inflexible, becoming profitable only for large production volumes.

Moreover, the successful result of the product is in this case mainly attributable to the initial quality of the glazes and their preliminary mixing, which clearly significantly complicates the workload for the manufacturer, who cannot get “real time feedback” on the effect which a certain degree of mixing or a certain combination of hues/colours may have on the product.

The purpose of the present invention is therefore to make available a system and method for printing products of the ceramic industry able to overcome the drawbacks of the prior art.

More precisely, it is a purpose of the present invention to provide a dispensing system and method for dispensing a slurry or glaze to make or to print products of the ceramics industry which is particularly versatile and flexible.

In addition, a further purpose of the present invention is to make a high performance dispensing system and method for dispensing a slurry or glaze to make or to print products of the ceramic industry, able to replicate to the smallest detail the pattern and appearance of a natural stone.

Said purposes are achieved by a dispensing system for dispensing a slurry or glaze for making or printing products of the ceramic industry, having the features of one or more of the claims from 1 to 11 and a dispensing method of a slurry or glaze for making or printing products of the ceramic industry having the features of one or more of claims 12 to 18.

In particular, the dispensing method involves the preparation of at least a first and a second reservoir respectively containing a first and a second slurry or glaze each having a liquid component and a solid particulate abrasive component, and the dispensing of a quantity of slurry respectively from the first and second reservoir inside a mixer.

It is to be noted that hereinafter the terms “slurry” and “glaze” are used without distinction to identify the liquid material contained in the reservoirs, without by so doing limiting the description to one or other expression.

According to one aspect of the present invention, the first or the second slurry inside the mixer are mixed to obtain a mixed fluid defined by an uneven (alternate) distribution of veining of said first and second slurry and subsequently the mixed fluid is dispensed from a print head.

Advantageously, this permits maximum flexibility and the possibility of real-time control of the appearance of the product actually printed.

Preferably, the maximum control of the process is obtained by adjusting, alternatively or jointly, the ratio of the amount of slurry coming from the various reservoirs and the mixing speed.

The mixing ratio, i.e. the ratio between the quantity of the first and second slurry (or glaze) mixed, is generally related to the chromatic hue of the product.

The mixing speed instead affects the “graphic pattern” of the mixed fluid and therefore of the product.

It is to be noted that in this text the expression “pattern” refers not so much (or not only) to the chromatic hue of the mixed fluid, as to its homogeneity and the distribution of the veining that is formed in the mixing of the two glazes.

Preferably the method provides for setting a mixing speed inversely proportional to the desired thickness of the veining.

The control parameters such as the mixing ratio and the mixing speed are determined depending on the effect to be achieved.

To this end, an image relative to a product or reference model is acquired, preferably by scanning, which is then processed to determine the mixing speed and/or the mixing ratio of the slurries in order to reproduce the hue of the reference product or model.

The method described above is preferably, but not necessarily, implemented by a dispensing system which the present invention also relates to, independently from the method.

Such system comprises a plurality of reservoirs designed to contain a respective slurry/glaze and at least one dispenser associated with the reservoirs and equipped with at least one dispensing outlet of the fluid.

According to the invention, the system comprises at least one mixer operatively interposed between the reservoirs and the dispenser, and configured to receive a slurry/glaze flow from the reservoirs and to send a corresponding flow of mixed fluid to the dispenser. In order to control the hue and/or homogeneity of the mixed fluid, the system comprises adjusting means, operatively interposed between each reservoir and the mixer, configured to adjust the flow rate of each fluid mixture flowing to the mixer.

The system further comprises a control unit associated with the adjusting means and preferably configured to drive them so as to control the ratio between the flow of fluid mixtures into the mixer depending on a reference signal related to a predetermined hue of the mixed fluid.

Preferably, in addition, the mixer is also provided with a stirring device moving at a predetermined speed, defined as mixing speed. The control unit is configured to modify the predetermined mixing speed according to a command given by an operator or to a reference signal in order to modify the homogeneity of the mixed fluid.

Advantageously, this way both the hue and homogeneity of the mixed fluid can easily be modified in real time and without the need for set-up times, to the benefit of system productivity.

These and other features and the relative advantages will be clearer from the following exemplary description of a preferred embodiment made thus non-limiting and therefore not exclusive, of a dispensing system for dispensing a slurry or glaze to make or to print products of the ceramic industry, as illustrated in the appended drawings, wherein:

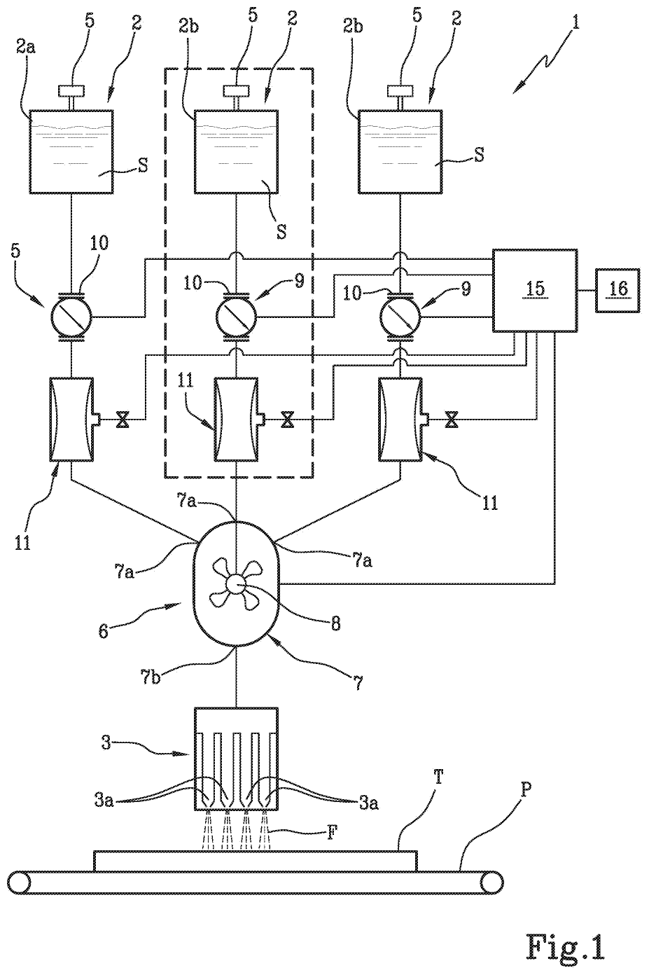

FIG. 1 shows a schematic view of a dispensing system for dispensing a slurry or glaze to make or to print products of the ceramic industry according to the present invention;

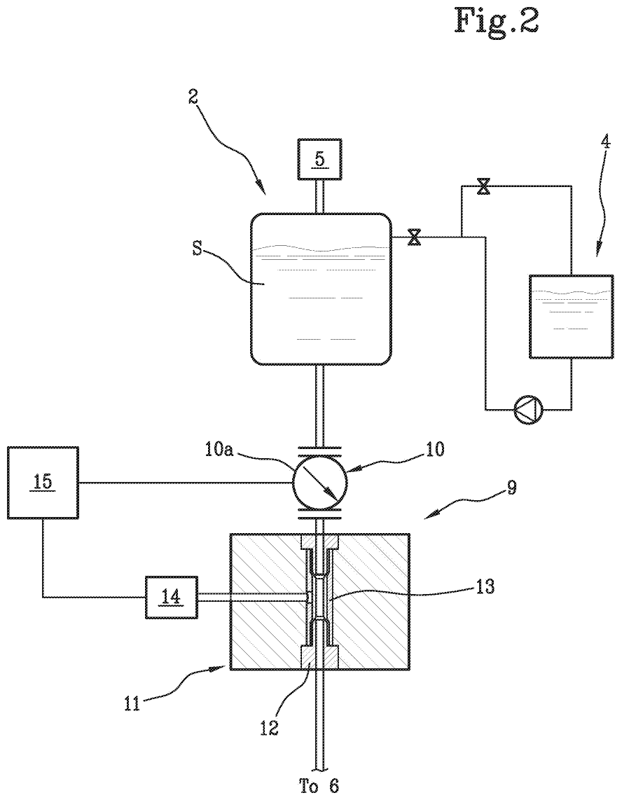

FIG. 2 shows a detailed view of a detail of the system of FIG. 1;

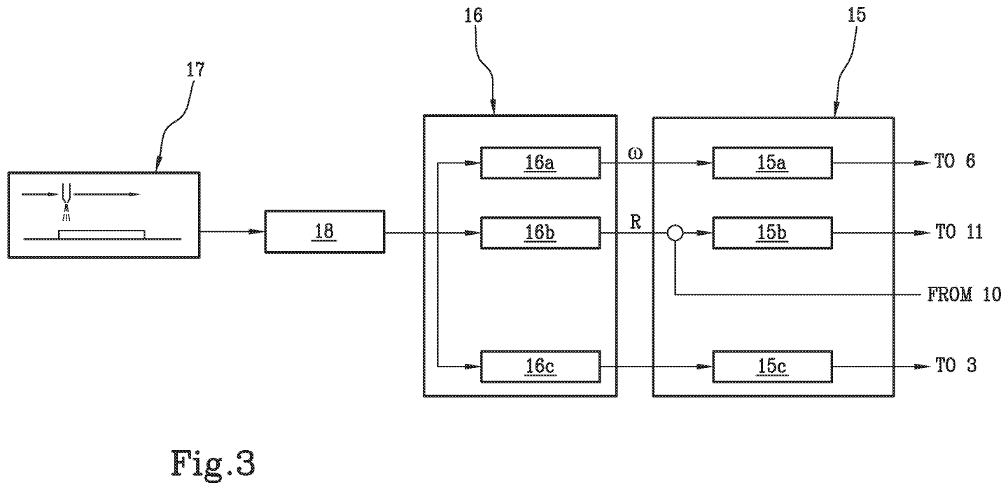

FIG. 3 schematically shows the steps and implementation logic of a method of dispensing a slurry or glaze for printing products of the ceramic industry according to the present invention.

With reference to the appended drawings, reference numeral 1 denotes globally a dispensing system for printing products of the ceramic industry.

It should be noted that, for illustrative purposes only and thereby without detracting from its general nature, the appended drawings show a dispensing system for printing products of the ceramic industry.

It should be noted that the expression “printing of products of the ceramic industry” means herein the colouring, decoration or “manufacture” of sheet-like elements, such as cement products, tiles, floor tiles, etc. via use of special glazes or powders.

Another type of processing which can be carried out by the device according to the present invention is the creation of “structures”.

Thus, the “creation of structures” means the dispensing of the material in a specially prepared mould, which is subsequently transported to the furnace to make the manufactured product.

It is to be noted in any case that the present invention is also applicable to other dispensing systems, not illustrated but still included in the spirit of the present invention.

The dispensing system 1 preferably comprises a plurality of reservoirs 2 suitable for containing a respective glaze S or fluid, and at least one dispenser 3 associated with the reservoirs 2 and equipped with at least one dispensing outlet 3a of the glaze S.

It should be noted that hereinafter, for descriptive simplicity and without losing in its generality, specific reference will be made to the “glaze S” to define the liquid contained in the reservoirs 2.

The above solely for the purpose of allowing a clear and exhaustive description of one of the embodiments of the invention, without prejudice to the fact that the system and the dispensing method according to the present invention are suitable for being used with other types of “fluid mixture”.

The dispenser 3 generally faces a work surface P on which the product T lies, which work surface may be fixed (with a moving head) or movable itself as shown schematically in FIG. 1.

In the embodiment illustrated, the dispenser 3 is a print head, while the outlet 3a is defined by a dispenser nozzle.

Hereinafter, therefore, without detracting from its generality, reference will be made indistinctly to the dispenser 3 or to the print head, to the outlet 3a or to the nozzle.

Preferably, there are at least two reservoirs 2, a first one 2a and a second one 2b, suitable for containing respectively a first and a second fluid (liquid) mixture, more preferably a first and a second glaze.

In any case, there may also be more than two reservoirs 2, such as in the embodiment illustrated in FIG. 1, where there are three reservoirs, i.e. a first one 2a, a second one 2b, and a third one 2c.

The fluid mixtures or glazes contained in the reservoirs may differ in colour, density, hue or particle size.

As a result, the mixing thereof may produce a mixed fluid (or compound) F varying with the varying of the concentration of each glaze.

It is to be noted that the fluid mixtures or glazes referred to herein generally comprise a liquid fraction and a solid fraction of abrasive particulate (or granular) material.

The particulate material contained in the glazes is typically defined by clay, feldspar or frit.

Preferably, such material has a particle size variable between 0.1 and 200 μm, more preferably between 0.3 and 120 μm.

In this regard, preferably each reservoir 2 is associated with a stirring or recirculation group 4 suitable for preventing the sedimentation of the solid fraction of the glaze S, which would obstruct the piping and prevent the proper functioning of the system 1.

The stirring or recirculation group 4 is therefore configured to stir the glaze S, thus agitating the solid particles inside the reservoir 2 and consequently preventing them from depositing.

Preferably, the stirring or recirculation group comprises a control system of the fluid level inside the reservoir (not shown).

Alternatively, however, the recirculation group 4 may be defined by a stirring device (not illustrated) configured to stir the material inside the reservoir 2.

A further (optional) feature of the reservoirs 2 here described is related to the pressurization; these reservoirs 2 are in fact pressurised and, preferably, configured to maintain a predetermined, constant, internal pressure.

In this view, the reservoirs 2 preferably comprise a compensation device 5 configured to maintain the pressure inside the reservoir 2 equal to a predetermined reference value.

Preferably, the compensation device 5 comprises a blowing unit suitable for pumping air inside the container as the level of glaze diminishes.

As regards the dispenser 3, it may be of various nature and structure, such as a print head, of the known type per se.

For example, the dispenser 3 may comprise a single outlet 3a or a plurality of outlets distributed and arranged to define a “bar” or array.

In the example illustrated, the print head is in fact provided with a plurality of nozzles arranged in rows in a predetermined direction in order to define a print array.

According to one aspect of the present invention, the system 1 comprises at least one mixer 6 operatively interposed between the reservoirs 2 and the dispenser 3.

This mixer 6 is therefore configured to receive a flow of mixed fluid S from the reservoirs 2 and to send a flow of mixed fluid F to the dispenser 3.

Consequently, hereinafter, the fluid mixture or glaze S will refer to the premix print material and the mixed fluid F will refer to the print material coming out of the mixer 6.

Preferably, the mixer 6 therefore comprises a containment body 7 having a plurality of inlets 7a, each associated (i.e. in fluid connection) with a respective reservoir 2 and an outlet 7b connected to the print head 3.

The mixer 6 comprises a stirring device 8 which is movable at a predetermined mixing speed “ω” for mixing and homogenising the mixtures coming from the reservoirs.

In the preferred embodiment, the stirring device comprises a plurality of blades (preferably rectangular) arranged in a column and secured at a central shaft which makes them rotate.

Between each reservoir 2 and the mixer 6, adjusting means 9 are also provided.

The adjusting means 9 are configured to adjust the amount of fluid mixture S that from each reservoir 2 reaches the mixer 6 depending on the desired (i.e. pre-set) hue for the mixed fluid F.

The adjusting means 9 are configured to operate on the amount of fluid mixture S that reaches the mixer 6 in the unit of time, thus on the flow rate, so as to allow a real-time control of the hue of the mixed fluid F.

Preferably, the adjusting means 9 comprise at least one detection device 10 for detecting the flow rate and a control valve 11, operatively interposed between each reservoir 2 and the mixer 6.

The detection device 10 is thus configured to acquire information related to the flow rate of fluid mixture S dispensed in output from the reservoir 2. The valve 11 is driven according to such information.

As will be better clarified below, in fact, the valve 11 is controlled in feedback in order to ensure that the correct hue of the mixed fluid is maintained corresponding to what is desired by the operator.

Preferably, the detection device 10 is a flowmeter 10a.

In the preferred embodiment, said detection device 10 is placed operatively upstream of said control valve 11 so as to make the control of the flow rate faster and more responsive.

The control valve 11 instead comprises a duct 12 placed along a connection pipe between the reservoir 2 and the mixer 6 and is provided with at least one deformable wall 13 movable between an operating position, in which it causes the creation of a bottleneck in the duct 12 that prevents or reduces the flow of the glaze S towards the mixer 6, and a rest position, in which it allows the flow of the fluid mixture S towards the mixer 6.

Advantageously, the presence of a deformable wall 13 along the duct 12 causes the occlusion action carried out by the same to be mostly tangential to the flow of the fluid mixture S, significantly reducing the impact with the solid particles of the mixture and making it easier to achieve a complete closure of the duct 12.

Preferably, moreover, the deformable wall 13 is made of elastically deformable material, more preferably rubber.

This is particularly beneficial both in terms of performance and duration.

In fact, the deformability of the wall 13, in particular of the rubber, guarantees the occlusion of the duct 12 even in the presence of particles of material interposed in the area of the bottleneck.

Furthermore, the “radial” action (relative to the main direction of the duct) of the wall together with its deformability means that, even if worn and therefore deprived of some layers of material, the wall still performs perfectly.

Preferably, the control valve 11 comprises a switching group 14, placed outside said duct 12 and associated with the deformable wall 13 to move it between the operating position and the rest position.

This switching group 14 is configured to generate on the deformable wall 13, outside the duct 12, a pressure variable between a maximum value, greater than the pressure inside the duct 12, and a minimum value, lower than the pressure inside the duct 12.

When the pressure imparted by the switching group 14 is greater than the pressure inside the duct 12, the deformable wall 13 moves towards the operating position.

When the pressure imparted by the switching group 14 is lower than the pressure inside the duct 12, the deformable wall 13 moves toward the rest position.

In this regard, it should be noted that the pressure in the duct 12 corresponds to the pressure inside the reservoir 2 and is therefore predetermined and preferably constant.

Advantageously, this way the control of the valve 11 results simple and easily programmable.

According to an aspect of the present invention, the printing system 1 comprises a control unit 15 associated with the adjusting means 9 and configured to drive them so as to adjust the inflow of each fluid mixture S into the mixer 6 according to a reference signal related to a predetermined hue of the mixed fluid.

In other words, the overall flow of glaze into the mixer 6 is blended in a controlled manner by the action of the adjusting means 9 driven by the control unit 15.

Preferably, the control unit 15 establishes a ratio between the glaze flow rates from the various reservoirs 2, by driving the adjusting means 9 according to said ratio.

This ratio is defined herein as the “mixing ratio”.

Advantageously, when the driving signal of the adjusting means 9 (and therefore of the mixing ratio R) changes, it is possible to change the hue and/or pattern of the mixed fluid F in real time, therefore without no need of shutting down the system or of set-up times.

Preferably, the adjusting means 9 are driven by feedback control.

More precisely, the control unit 15 is configured to compare a reference signal related to the flow rate of each fluid mixture with the actual current flow rate measured by the detection device 10 (i.e. flowmeter 10a), thereby driving the valve 11 accordingly.

More precisely, the control unit 15 drives the switching group 14, which varies the pressure acting on the face of the deformable wall 13, out of the duct 12, to switch it between the operating position and the rest position.

Advantageously, since in the preferred embodiment the detection device 10 is placed upstream of the valve 11, the control is efficient and very responsive, allowing production quality to be maximized.

According to a further aspect of the present invention, the control unit 15 is also configured to drive the mixer 6.

More precisely, the control unit 15 is programmed to adjust the predetermined mixing speed “ω” according to a command imparted by an operator or a variation of the reference signal related to it.

It should be noted that, advantageously, the mixing speed “ω” is related to the pattern of the mixed fluid, impacting on the homogeneity of mixing and the thickness of the veinings to be recreated.

In this regard, the control unit 15 is configured to increase the mixing speed “ω” in order to reduce the thickness of said veinings or reduce the mixing speed “ω” in order to increase the thickness of said veinings.

More precisely, the printing system 1 is preferably equipped with a command module 16 associated with the control unit 15 and configured to set or allow an operator to set at least the ratio R and the mixing speed “ω” using appropriate interface modules 16a, 16b.

Preferably, the command module 16 also includes an interface module 16c suitable for defining the driving parameters of the dispenser 3 (e.g. of the print head).

These parameters are thus modifiable independently or as a result of a command given by an operator even during the operation of the system.

In this regard, the control unit 15 is therefore equipped with a plurality of control modules 15a, 15b, 15c, each associated with a respective device in order to drive it.

More precisely, a first control module 15a is operatively associated with the mixer 6 to drive the stirrer device and to control the mixing speed “ω”.

A second control module 15b is associated with the valves 11 and the detection devices 10 to:
receive from the detection device 10 a signal representing the flow of the fluid mixture S;
compare this signal with the corresponding driving parameter sent by the command module 16;
send a drive signal to the valve 11 (i.e. to the switching group 14) depending on such comparison.

A third control module 15c is preferably present to control and to drive the dispenser 3 according to the desired printing layout.

It is to be noted that preferably the above parameters are established as a result of the analysis of a natural stone whose pattern and/or hue are to be re-created “artificially”.

In this view, in a preferred embodiment, the system 1 comprises or is associated with an acquisition module 17 configured to detect and store the image of a product or of a reference model, and with a processing module 18 (or image processing module) configured to determine at least the mixing ratio R and/or the mixing speed “ω” depending on such processing.

The command module 16 is therefore set according to the processing performed by the processing module 18.

The system 1 described so far is useful for implementing a dispensing method of a slurry or glaze for the manufacture or printing of products of the ceramic industry, the method being, independently from the system, also included in the object of the present invention.

The steps of the method, which preferentially shall be considered for use in the printing of ceramic tiles, will therefore be described in detail below.

Such method involves preparing a plurality of reservoirs 2, preferably at least a first reservoir 2a and a second reservoir 2b containing respectively a first and a second fluid mixture (or a first and a second glaze), each having a liquid component and a solid particulate abrasive component.

The method then provides for making a quantity of glaze flow from the first reservoir 2a and second reservoir 2b, respectively, into the mixer 6 and mixing these fluid mixtures together to obtain a mixed fluid F defined by an uneven (alternating) distribution of veinings of said first and second glazes.

In accordance with the above, the glazes and reservoirs may be even more than two in number, for example three, as shown in FIG. 1.

Once the fluid mixtures have been mixed and the mixed fluid F is obtained, the latter is dispensed by the dispenser 3.

In order to obtain the correct hue and/or the correct pattern during printing, the method provides for defining the mixing ratio R between the quantity of the first and the second fluid mixture (possibly of even more fluid mixtures or glazes).

Depending on such mixing ratio R, the flow rate of each fluid mixture into the mixer 6 is suitably adjusted, preferably via the adjusting means 9 described above.

Preferably, the flow control step is carried out by controlling the opening or closing condition of the control valve 11 operatively placed between each reservoir 2 and the mixer 6 according to a flow rate measured upstream or downstream of said valve 11.

Furthermore, the method provides, preferably in conjunction with the step of defining the mixing ratio R, a correlation step between a degree of homogeneity (i.e. pattern) desired for the mixed fluid and the mixing speed.

As already mentioned above, the higher the mixing speed “ω”, the more homogeneous the mixed fluid is and with thin veinings; conversely, if the mixed fluid (and therefore the tile) is to have a very fragmented pattern, with clearly visible veinings, the mixing speed “ω” is slowed down.

The correlation step is in fact intended to correlate the mixing speed “ω” with a thickness of the veinings of the individual fluid mixtures in the mixed fluid F.

Thus, the mixing speed “ω” is set as inversely proportional to the thickness of the desired veining.

In view of the fact that, preferably, the mixed fluid is prepared to perform a print type as close as possible to a reference model, the method preferentially provides for acquiring an image relative to a product or reference model and processing such image to determine the mixing speed “ω” and/or the mixing ratio R between the fluid mixtures in order to reproduce the appearance (i.e. hue, homogeneity and distribution of the veinings) of the manufactured product or reference model.

In other words, a processing step is provided in which the mixing speed “ω” and/or the mixing ratio R between the fluid mixtures are determined depending on the characteristics of the acquired image.

The invention achieves the proposed objects and permits important advantages.

In fact, the possibility of controlling the mixing of the glazes, even in real time, by acting on the flow rates in input to the mixer and, preferably, on the mixing speed, makes the system (and the method implemented by it) highly flexible and versatile.

In addition, being able to independently and autonomously manage the quantity of mixed glaze and the mixing manner, it is possible to obtain the most varied graphic effects on the product.

Moreover, by exploiting the structure of the valve with a radially deformable wall, the flow rate control can be carried out in a very simple and precise manner, ensuring in any case maximum resistance to wear and reliability.

1. A dispensing system for dispensing a slurry or glaze to make or print products of the ceramic industry, in particular ceramic tiles, comprising:
a plurality of reservoirs (2) suitable for containing a respective fluid mixture or glaze (S);
at least one dispenser (3) associated with the reservoirs (2) and equipped with at least one outlet (3a) for dispensing the fluid mixture (S);
characterised in that it comprises:
at least one mixer (6) operatively interposed between the reservoirs (2) and the dispenser (3), and configured to receive the fluid mixture (S) from each reservoir (2) and to send a mixed fluid (F) to the dispenser (3);
adjusting means (9) operatively interposed between each reservoir (2) and the mixer (6);
a control unit (15) associated with the adjusting means (9) and configured to drive them so as to control the mixing ratio (R) between the flow rates of fluid mixtures (S) into the mixer (6) depending on a reference signal related to a predetermined hue of the mixed fluid.

2. The dispensing system according to claim 1, characterised in that it comprises a stirring or recirculation group (4) associated with each reservoir (2) and configured to stir the glaze (S) inside said reservoir (2) in order to prevent the sedimentation of particulate material.

3. The dispensing system according to claim 1, characterized in that said reservoirs (2) are pressurised.

4. The dispensing system according to claim 1, characterized in that each reservoir (2) comprises a compensation device (5) configured to maintain the pressure in the reservoir (2) equal to a predetermined reference value.

5. The dispensing system according to claim 1, characterized in that said adjusting means (9) comprise at least one detection device (10) for detecting the flow rate and a control valve (11) operatively interposed between each reservoir (2) and said mixer (6).

6. The dispensing system according to claim 5, characterized in that said detection device (10) is a flowmeter (10a).

7. The dispensing system according to claim 5, characterized in that said detection device (10) is placed operatively upstream of said control valve (11).

8. The dispensing system according to claim 5, characterised in that said control valve (11) comprises a duct (12) placed along a connection pipe between the reservoir (2) and the mixer (6), and comprising at least one deformable wall (13) moveable between an operating position, in which it determines the creation of a bottleneck in the duct (12) that prevents or reduces the flow of the fluid mixture (S) towards the mixer (6), and a rest position, in which it allows the flow of the fluid mixture (S) towards the mixer (6).

9. The dispensing system according to claim 8, characterised in that said control valve (11) comprises a switching group (14), placed outside said duct (12) and associated with said deformable wall (13) to switch it between the operating position and the rest position.

10. The dispensing system according to claim 1, characterized in that said mixer (6) comprises a stirring device (8) moveable at a predetermined mixing speed; said control unit (15) being configured to change the predetermined mixing speed (ω) according to a command given by an operator or to a reference signal.

11. The dispensing system according to claim 10, characterized in that said plurality of reservoirs (2) contains a corresponding number of fluid mixtures (S) of different colours, wherein the mixer (6) is configured to mix them so as to generate a mixed fluid (F) defined by a distribution of alternating veinings of said fluid mixtures (S); said control unit (15) being configured to:
increase the mixing speed (ω) in order to reduce the thickness of said veinings, or
reduce the mixing speed (ω) in order to increase the thickness of said veinings.

12. A dispensing method for dispensing a slurry or glaze for making or printing products of the ceramics industry, in particular a ceramic tile, comprising the following steps:
providing at least a first (2a) and a second reservoir (2b) containing respectively a first and a second fluid mixtures (S) each having a liquid component and a solid particulate abrasive component;
dispensing a quantity of fluid mixture respectively from the first reservoir (2a) and from the second reservoir (2b) inside a mixer (6);
mixing said first and second fluid mixtures (S) inside the mixer (6) to obtain a mixed fluid (F) defined by a non-homogeneous distribution of veinings of said first and second fluid mixtures (S);
dispensing the mixed fluid (F) from a dispenser (3).

13. The dispensing method according to claim 12, characterized in that it comprises a step of defining a mixing ratio (R) between the quantity of the first and second glazes dispensed to the mixer (6); said step of dispensing the glazes comprising an adjustment of the flow rate of the first and second glazes dispensed respectively from the first and second reservoirs, according to said mixing ratio (R).

14. The dispensing method according to claim 13, characterised in that said step of adjustment of the flow rate is carried out by controlling the opening or closing condition of a control valve (11) operatively placed between each reservoir (2) and the mixer (6), according to a flow rate detected upstream or downstream of said valve (11).

15. The dispensing method according to claim 12, characterized in that it comprises the following steps:
correlation between a degree of homogeneity desired for said mixed fluid and a mixing speed (ω);
driving a stirring device (8) of the mixer (6) at said mixing speed (ω).

16. The dispensing method according to claim 15, characterized in that said correlation step involves correlating said mixing speed (ω) to a thickness of the veinings of said first and second fluid mixtures (S) in the mixed fluid (F).

17. The dispensing method according to claim 16, characterized in that said correlation step involves setting a mixing speed (ω) inversely proportional to the desired thickness of the veinings.

18. The dispensing method according to claim 13, characterized in that it comprises the following steps:
acquiring an image relative to a manufactured product or to a reference model;
processing said acquired image to determine the mixing speed (ω) and/or the mixing ratio (R) between the fluid mixtures in order to reproduce the appearance of the reference model or of the manufactured product.
